(19) United States
(12) Patent Application Publication
(10) Pub. No.: US 2004/0210490 A1
(43) Pub. Date: Oct. 21, 2004

(54) Tool for managing bids

(76) Inventors: Karl F. Almstead, Philadelphia, PA (US); Lars Lindberg, Stokholm (SE); Lars Ersmarker, Skoude (SE)

Correspondence Address: Barry S Newberger, Winstead Sechrest & Minick, 5400 Renaissance Tower, 1201 Elm Street, Dallas, TX, 75270, US

(21) Appl. No.: 10/484,372

(22) PCT Filed: Aug. 30, 2001
(86) PCT No.: PCT/US01/26967

(51) Int. Cl. G06F 17/60

(52) U.S. Cl. 705/26

(57) ABSTRACT

A method, computer program product and system for managing bids. A bid request may be transmitted to a recipient that may itself become a bid requester thereby being able to submit one or more bid requests to other entities. A bid request may generically refer to a request to bid on line item(s). A recipient of one or more bid requests may further be allowed to aggregate one or more line items and the accompanying documentation, e.g., agreements, drawings, if any, in the one or more received request, into one or more new requests to be submitted to other entities. Furthermore, a recipient of one or more responses to one or more bid requests may import data related to one or more line items in one or more received responses into one or more new responses to be submitted to other entities.

### CROSS-REFERENCE TO RELATED APPLICATION

This application is a 371 of International Patent Application No. PCT/US01/26967 filed on 30 Aug. 2001, which claims priority to and benefit of U.S. Provisional Application No. 60/307,754 filed on 25 Jul. 2001.

### FIELD OF INVENTION

The present invention relates to the field of software tools, and more particularly to a tool that facilitates the management of requests to submit bids and the responses to those requests.

### BACKGROUND OF INVENTION

Many projects exist that require various goods and/or services to be provided in order to complete the project. Projects in almost every sector of the economy, including for example projects in the manufacturing, services, maintenance, construction and telecommunications industries, require various goods and/or services to be provided in order to complete the project. When planning such projects, the entity responsible for the project may issue requests to bid on opportunities to provide particular goods and/or services, commonly referred to as a “scope of work,” that are necessary to complete the project. For example, in a project to construct a building, a general contractor may issue requests to other entities, e.g., sub-contractors, to bid on contracts for such tasks as installing windows, plumbing, wiring, building the structural frame of the building, performing evacuation services, etc., that are necessary to complete the project. The general contractor may issue a request to bid on a particular scope of work containing items that need to be completed to other entities, e.g., sub-contractors, in order to select the best entity to perform the particular scope of work. The general contractor may then select one of the sub-contractors to complete the particular scope of work.

Typically the entity responsible for the project may issue a request to bid, commonly referred to as a “bid request,” containing a list of line items that need to be provided in order to complete the project. The entity responsible for the project may need to provide documentation, e.g., drawings, diagrams, specifications, in order to assist the recipient of the bid request in understanding the bid request. The line items provide the detail for the scope of work as stated above. If an entity receiving such a request decides to respond, it may need to include at least an estimate of the costs for completing such line item(s). Such costs may include, for example, material costs, labor costs, insurance costs, and the like. Once these costs are determined, the recipient may add a profit margin to the estimated costs and then submit its response back to the issuer of the request.

In order to accurately assemble the costs to be offered in its response, the recipient may need to solicit bids for some or all of those line items from other entities. That is, the recipient of the bid request may need to then issue a bid request itself on a portion of those items in the request received. Furthermore, a recipient may receive multiple bid requests from the same or different requesters relating to the same or different projects. These multiple requests may include line items and accompanying documentation, e.g., agreements, drawings, that need to be procured by the recipient. To obtain better pricing or terms, the recipient may want to combine line items found in multiple requests into a new request to solicit bids from sub-contractors, material suppliers, manufacturers or other types of vendors or suppliers. Traditional methodologies for issuing requests and preparing responses are both time and labor intensive, and therefore, costly. Moreover, the traditional methodologies are vulnerable to human error and have proven ill suited for projects of increasing magnitude and complexity where the bidding process has expanded geometrically.

It would therefore be desirable to develop a tool that allows a recipient of a bid request to submit one or more requests to bid to other entities on a portion of the line items in the received request. It would further be desirable to develop a tool that imports data related to one or more line items in one or more responses to one or more bid requests into one or more new responses to be submitted to the appropriate entity. It would further be desirable to develop a tool that aggregates the line items and the accompanying documentation, e.g., agreements, drawings, from multiple requests into one or more new requests that may be submitted to other entities. It would further be desirable to develop a tool that selects and imports data related to particular line items in one or more responses to an aggregated request into one or more new responses to be submitted to the appropriate entity.

### SUMMARY OF INVENTION

The problems outlined above may at least in part be solved in some embodiments by a tool that allows a recipient of a bid request to become a bid requester thereby being able to submit one or more bid requests to other entities. Furthermore, the tool may allow a user to import data related to one or more line items contained in one or more responses to one or more bid requests into one or more new responses to be submitted to the appropriate entity. Furthermore, the tool may allow a user to aggregate the line items and the accompanying documentation, e.g., agreements, drawings, if any, in the received requests, into one or more new requests to be submitted to other entities. Furthermore, the tool may allow a user to select and import data related to particular line items from one or more responses to an aggregated request into one or more new responses to be submitted to the appropriate entity.

In one embodiment of the present invention, a method for managing bids may comprise the step of one or more requesters, e.g., owners, operating at a particular level of classification, e.g., first level of classification, issuing one or more bid requests to one or more users, e.g., general contractors, operating at the next lower level of classification. Levels of classifications may refer to stages at which the user(s) may be involved in the process of bidding on a particular project. The bid request may comprise a plurality of line items as well as any accompanying documentation, e.g., agreements, drawings, if any. Upon a user receiving one or more bid requests from one or more users operating at a next higher level of classification, the user may issue a new bid request to one or more users operating at a next lower level of classification, e.g., third level of classification corresponding to sub-contractors. The new bid request issued by the user may include one or more of the plurality of line items as well as any accompanying documentation, if any, in the received bid request into the new bid request. In addition, the new bid request may include new line items or new documentation added by the initial recipient. A user, e.g., sub-contractor, receiving the new bid request may further issue a new bid request as described above. The user, e.g., sub-contractor, may further select line item(s) as well as any accompanying documentation, in more than one received bid request into a new bid request to be issued to one or more users with a next lower level of classification, e.g., fourth level of classification corresponding to sub-sub-contractors.

In one embodiment of the present invention, the recipient of one or more responses to bid requests previously submitted, e.g., sub-contractor, may import data, e.g., description of goods, price quotes, related to one or more selected line items in the received responses into a new response to be submitted to a user operating at a next higher level of classification, e.g., general contractor. If the received responses are responses to the same line item(s) then the user may select particular data, if any, from any one of those responses related to a line item with more than one response. That data related to the line item may then be imported into one or more responses to be submitted to one or more users operating at a next higher level of classification. The user may further select particular data, if any, related to a line item that does not have more than one response. That data related to the line item may then be imported into one or more responses to be submitted to one or more users operating at a next higher level of classification. If the received responses are not responses to the same line items then the user may import data related to one or more line items in one or more responses into one or more responses to be submitted to one or more users operating at a next higher level of classification. The received responses that are imported into the new response may be hidden to the user operating at a next higher level of classification that receives the new response. That is, these bid responses may not be separately accessible by the user operating at a next higher level of classification that receives the new response.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF DRAWINGS

For a more complete understanding of the present invention, and the advantages thereof, reference is now made to the following descriptions taken in conjunction with the accompanying drawings, in which:

A better understanding of the present invention can be obtained when the following detailed description is considered in conjunction with the following drawings, in which:

FIG. 1 illustrates an embodiment of a network system configured in accordance with the present invention;

FIG. 2 illustrates an embodiment of a server configured in accordance with the present invention;

FIG. 3 illustrates an embodiment of a client configured in accordance with the present invention;

FIG. 4 illustrates a hierarchical diagram of an overall process for transmitting bid requests in accordance with the present invention;

FIG. 5 illustrates a hierarchical diagram of an overall process for responding to bid requests in accordance with the present invention;

FIG. 6 is a flowchart of a method for managing Requests For Information (RFI's) in accordance with the present invention;

FIG. 7 illustrates a hierarchical diagram illustrating aggregation in accordance with the present invention; and

FIG. 8 is a flowchart of a method for managing bids in accordance with the present invention.

### DETAILED DESCRIPTION OF THE INVENTION

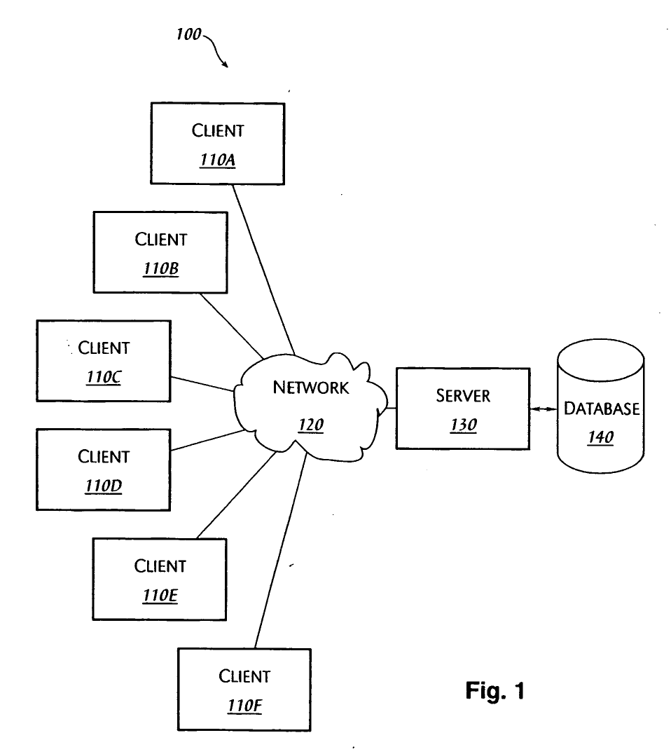

The principles of the present invention and their advantages are best understood by referring to FIG. 1—Database System.

FIG. 1 illustrates one embodiment of the present invention of a database system 100. System 100 may comprise a plurality of clients 110A-F coupled to a server 130 via a network 120. Network 120 may be a Local Area Network (LAN), e.g., Ethernet, Token Ring, ARCnet, or a Wide Area Network (WAN), e.g., Internet. Server 130 may be configured to store and retrieve data, e.g., bid requests, responses to bid requests, to and from, respectively, a database 140. Clients 11A-F may collectively or individually be referred to as clients 110 or client 110, respectively. It is noted that system 100 may comprise any number of clients 110 as well as any number of servers 130 and databases 140 and that FIG. 1 is illustrative. It is further noted that the connection between client 110 and network 120 may be any medium type, e.g., wireless, wired. It is further noted that client 110 may be any type of network access device, e.g., wireless, Personal Digital Assistant (PDA), cell phone, personal computer system, workstation, web terminal, Internet appliance, configured with the capability of connecting to network 120 by either a wired or wireless connection. It is further noted that system 100 may be any type of system that has at least one server 130 and at least one client 110 and that FIG. 1 is not to be limited in scope to any one particular embodiment.

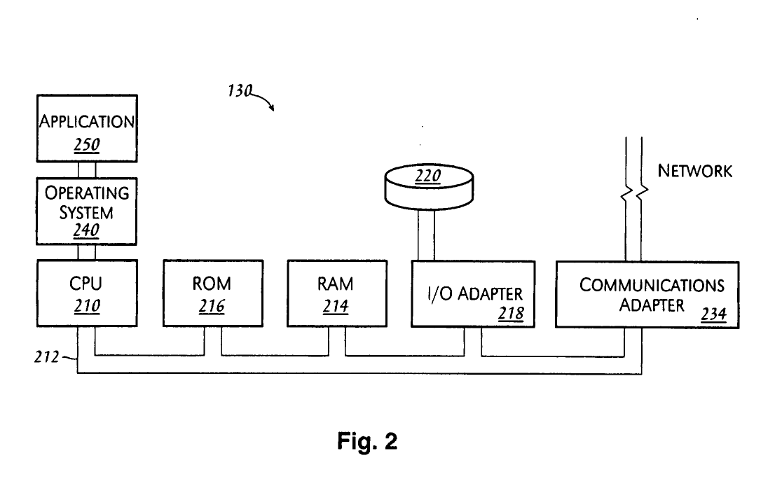

FIG. 2—Hardware Configuration of Server

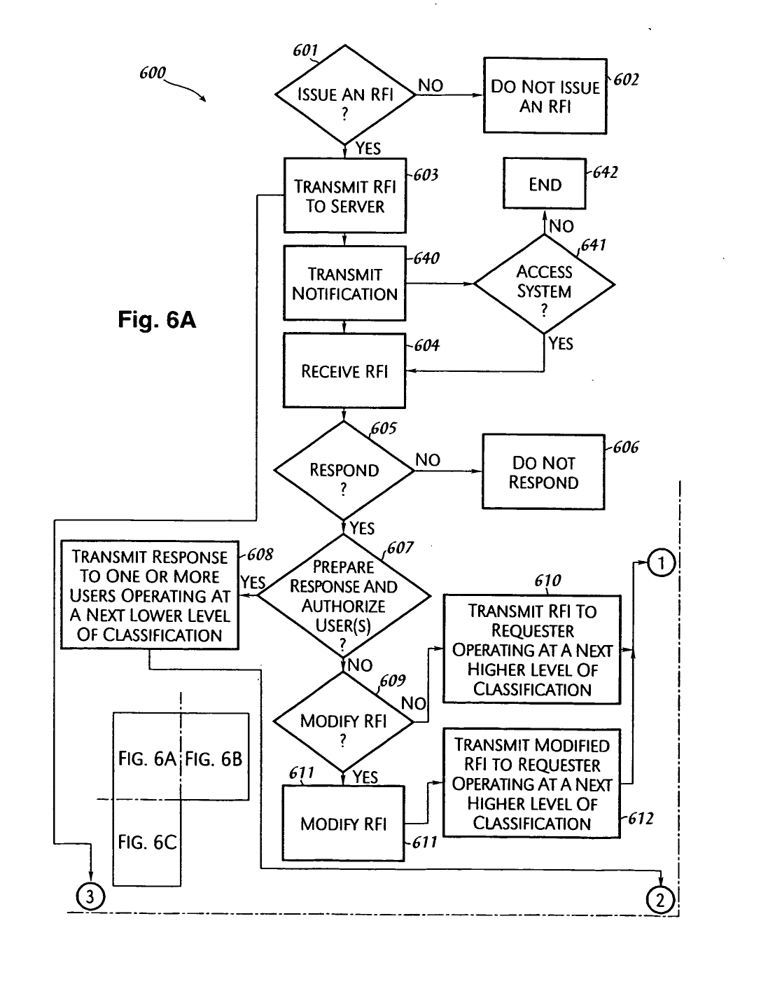

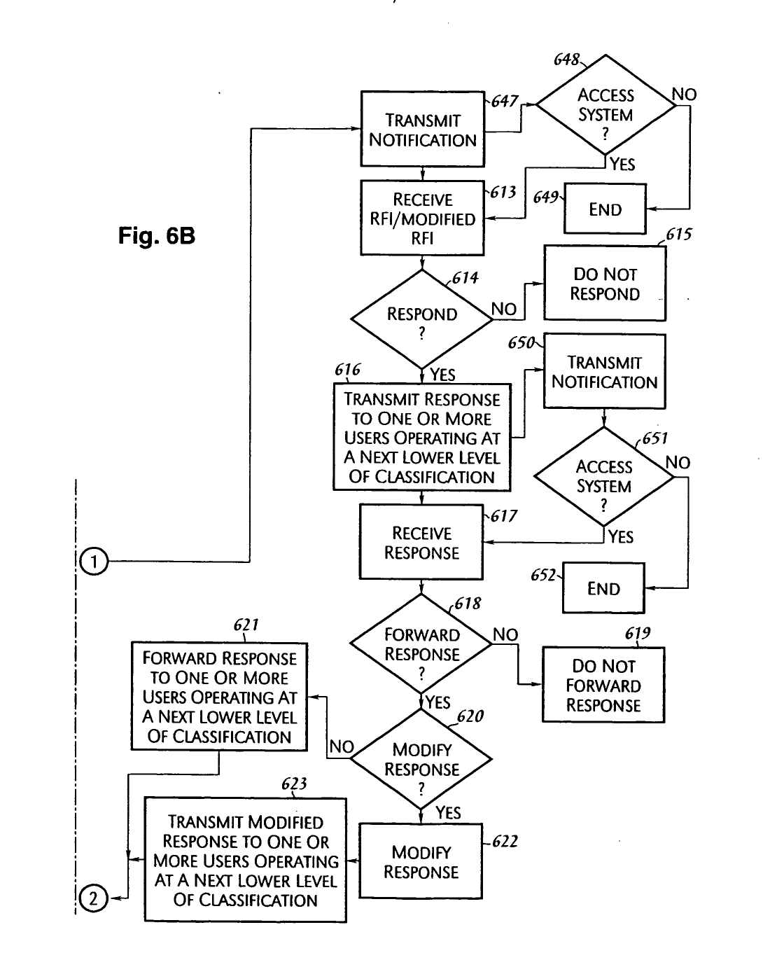

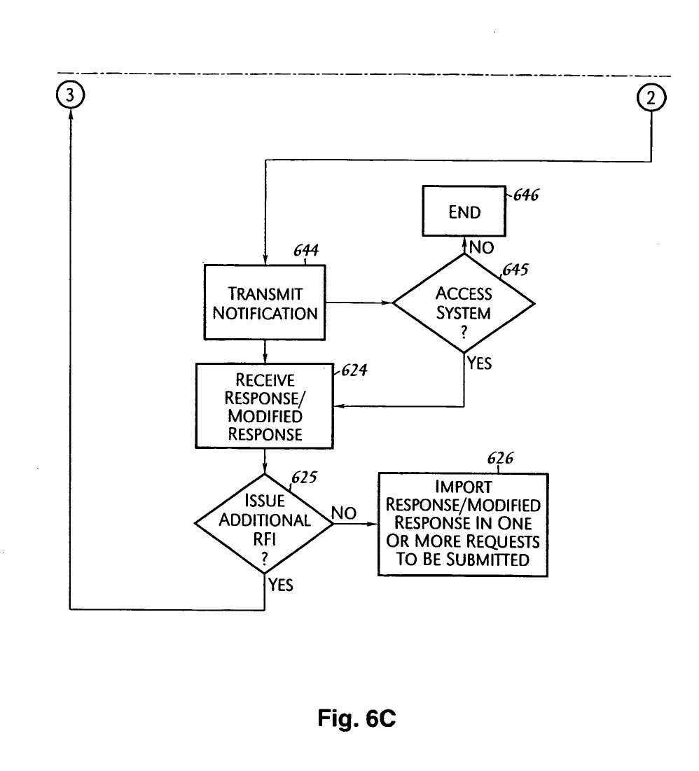

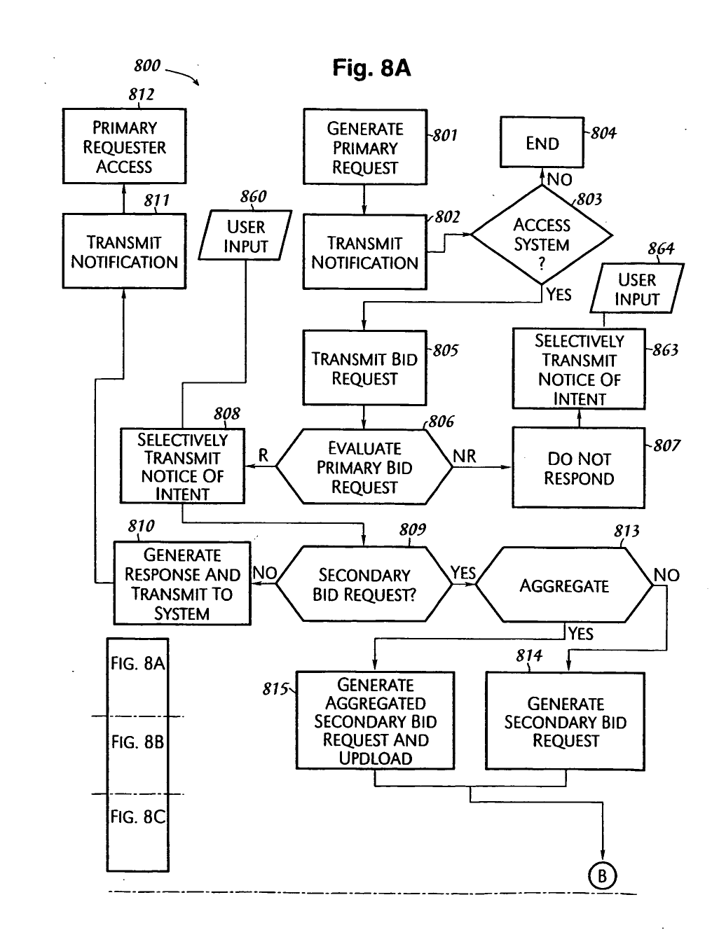

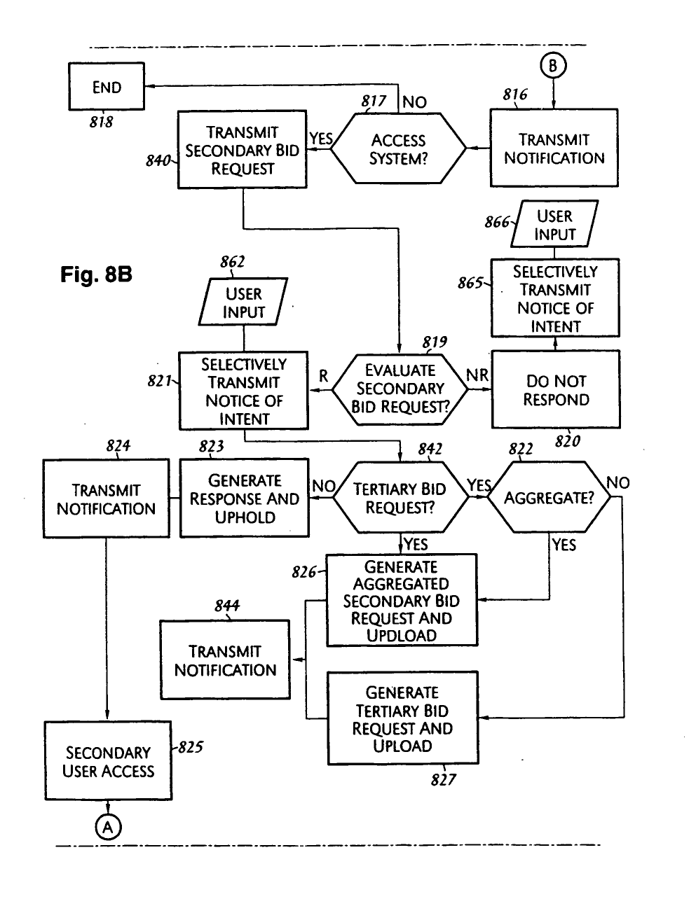

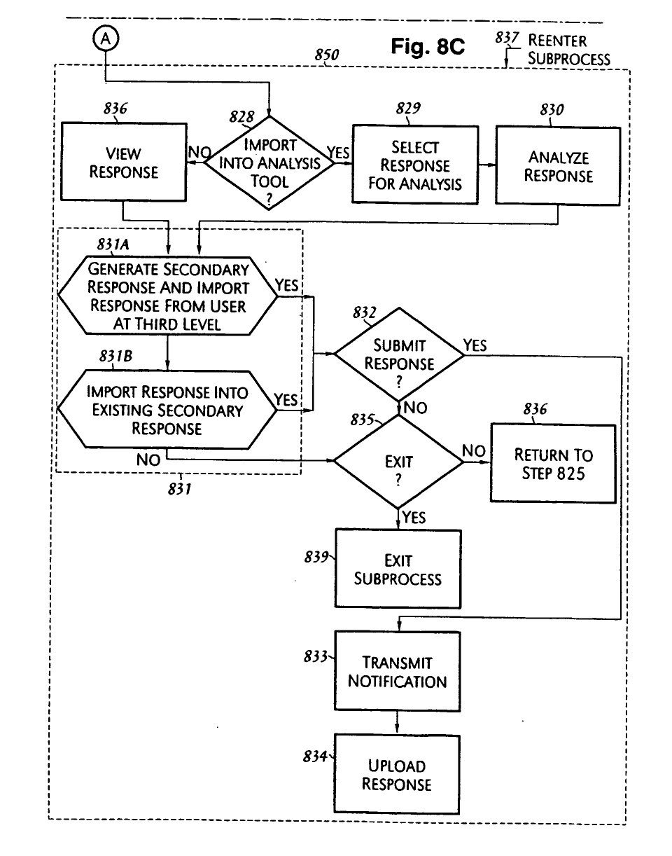

FIG. 2 illustrates an embodiment of the present invention of server 130. Referring to FIG. 2, server 130 may comprise a central processing unit (CPU) 210 coupled to various other components by system bus 212. An operating system 240, e.g., AIX, UNIX, runs on CPU 210 and provides control and coordinates the function of the various components of FIG. 2. Application 250, e.g., program for transmitting notifications as well as storing and retrieving requests and responses stored in database 140 as described in FIGS. 6 and 8, runs in conjunction with operating system 240 which implements the various functions to be performed by application 250. Read only memory (ROM) 216 is coupled to system bus 212 and includes a basic input/output system (“BIOS”) that controls certain basic functions of server 130. Random access memory (RAM) 214, I/O adapter 218 and communications adapter 234 are also coupled to system bus 212. It should be noted that software components including operating system 240 and application 250 are loaded into RAM 214 which is the computer system's main memory. I/O adapter 218 may be a small computer system interface (“SCSI”) adapter that communicates with disk unit 220, e.g., disk drive. It is noted that the program of the present invention that may transmit notifications as well as store and retrieve requests and responses in database 140 as described in FIGS. 6 and 8 may reside in disk unit 220 or in application 250. Communications adapter 234 interconnects bus 212 with network 120 thereby enabling server 130 to communicate with client 1110.

Implementations of the invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by server 130, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and stored or transmitted (or a portion thereof) when desired to the user's workstation or accessed by a user via a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

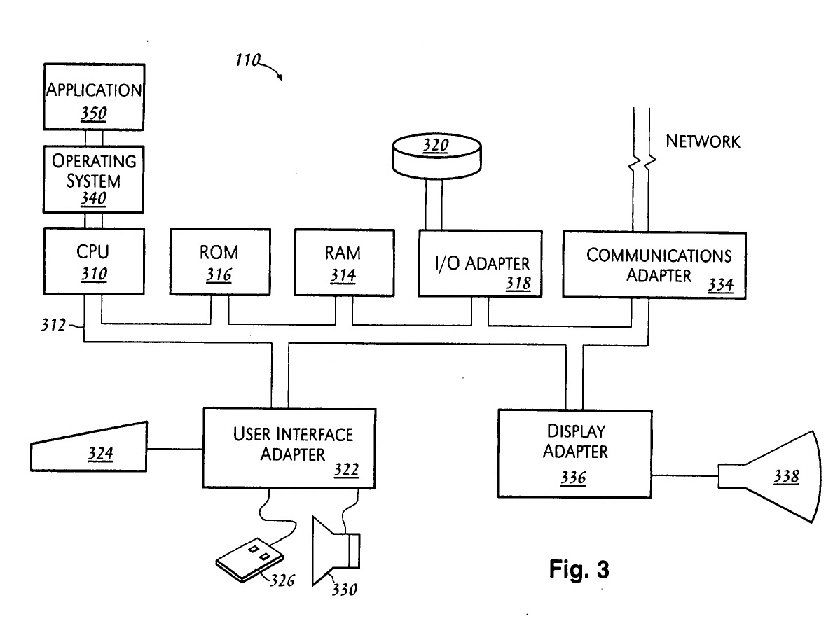

FIG. 3—Hardware Configuration of Client

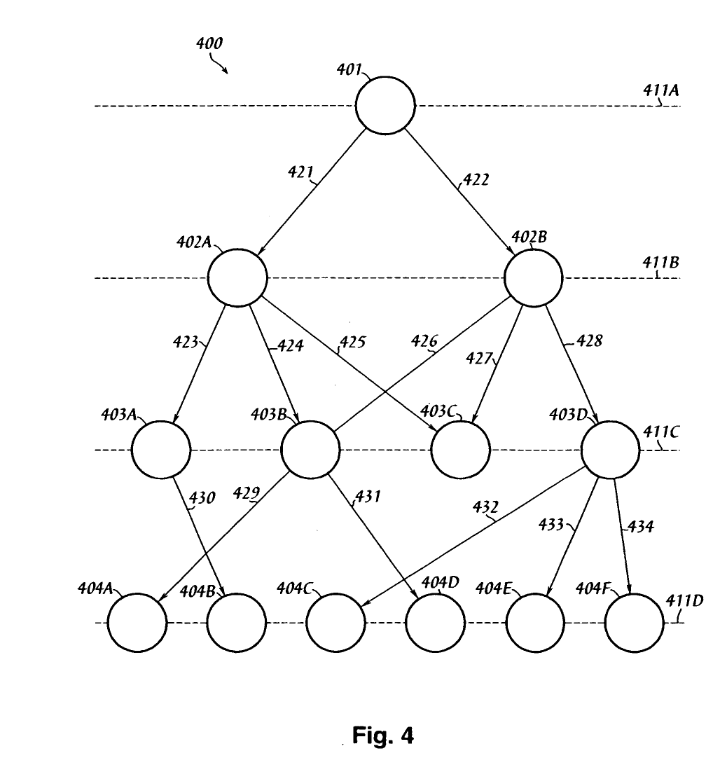

FIG. 3 illustrates a typical hardware configuration of client 110 which is representative of a hardware environment for practicing the present invention. While the description below describes the internal connections in client 110 as hard wired it is understood by a person of ordinary skill that the connections may be wireless. Client 110 has a central processing unit (CPU) 310 coupled to various other components by system bus 312. An operating system 340 runs on CPU 310 and provides control and coordinates the function of the various components of FIG. 3. An application 350 in accordance with the principles of the present invention runs in conjunction with operating system 340 and provides output calls to operating system 340 where the output calls implement the various functions or services to be performed by application 350. Application 350 may include for example, a program for managing bids, as described in FIGS. 4-8. Read only memory (ROM) 316 is coupled to system bus 312 and includes a basic input/output system (“BIOS”) that controls certain basic functions of client 110. Random access memory (RAM) 314, I/O adapter 318, and communications adapter 334 are also coupled to system bus 312. It should be noted that software components including operating system 340 and application 350 are loaded into RAM 314 which is the computer system's main memory. I/O adapter 318 may be an integrated drive electronics (“IDE”) adapter that communicates with disk unit 320, e.g., disk drive. It is noted that the program of the present invention that manages bids, as described in FIGS. 4-8, may reside in disk unit 320 or in application 350.

Communications adapter 334 interconnects bus 312 with network 120 enabling client 110 to communicate with server 130. Input/Output devices are also connected to system bus 312 via a user interface adapter 322 and display adapter 336. Keyboard 324, mouse 326 and speaker 330 are all interconnected to bus 312 through user interface adapter 322. Event data may be input to client 110 through any of these devices. A display monitor 338 is connected to system bus 312 by display adapter 336. In this manner, a user is capable of inputting to client 110 through keyboard 324 or mouse 326 and receiving output from client 110 via display 338 or speaker 330.

Implementations of the invention include implementations as a computer system programmed to execute the method or methods described herein, and as a computer program product. According to the computer system implementation, sets of instructions for executing the method or methods are resident in the random access memory 314 of one or more computer systems configured generally as described above. Until required by the computer system, the set of instructions may be stored as a computer program product in another computer memory, for example, in disk drive 320 (which may include a removable memory such as an optical disk or floppy disk for eventual use in the disk drive 320). Further, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological, or some other physical change.

FIG. 4—Hierarchical Diagram of Overall Process for Transmitting Bids

FIG. 4 is a hierarchical diagram 400 of the overall process for transmitting bids in accordance with the present invention. Hierarchical diagram 400 may illustrate users of clients 110, which are represented as circles, transmitting bids to users in different layers or levels of classification 411A-D which are represented by the dashed lines. The levels of classification 411A-D may refer to the stage the user(s) may be involved in the process of bidding on a particular project or portion thereof. For example, level of classification 411A may refer to the first stage in the bidding process. Level of classification 411B may refer to the second stage in the bidding process. Level of classification 411C may refer to the third stage in the bidding process. Level of classification 411D may refer to the fourth stage in the bidding process. Levels of classification may collectively or individually be referred to as levels of classification 411 or level of classification 411, respectively. It is noted that a single entity may engage in the bidding process at separate levels of classification 411 with respect to multiple bid requests relating to different projects or even the same project. Furthermore, hierarchical diagram 400 may further illustrate the flow of requests from one or more users at a next higher level of classification 411 to one or more users operating at a next lower level of classification 411 as indicated by arrows 421-434. It is noted that hierarchical diagram 400 is illustrative and that the bidding process may comprise any number of stages, i.e., any number of levels of classification 411, involving any number of users, i.e., each level of classification 411 may comprise any number of users.

As stated above, hierarchical diagram 400 illustrates the overall process for transmitting bids in accordance with the present invention. A bid request may generically refer to a request to bid on line item(s) but could refer to a request for proposal or quotation as those terms would be understood by a person of ordinary skill in the art. Furthermore, the bid request may include some or all of the documentation, e.g., drawings, diagrams, specifications, instructions, agreements related to a specific line item or the request in general. Note, that in an embodiment of the present invention, such as in a Web-based environment, the bid request may include a link, or other similar pointer to the documentation, or to portions thereof, rather than the documentation itself. Furthermore, the bid request may refer to the same or different projects where the line items in the bid request may be associated with different projects.

As stated above, hierarchical diagram 400 illustrates the transmission of bid requests from one or more users operating at a next higher level of classification 411 to one or more users operating at a next lower level of classification 411. For example, the first stage of the bidding process may involve one or more users, e.g., owners, issuing one or more requests (hereinafter referred to as primary bid requests) to bid on one or more line items that need to be completed for a particular project to one or more other users. A user involved in the first stage of the bidding process, e.g. user 401, may be said to be operating at a first level of classification (hereinafter referred to as the primary requester). The second stage of the bidding process may involve one or more users, e.g., general contractors, receiving one or more requests to bid from a user operating at a first level of classification. For example, users 402A-B receive a request from user 401 as illustrated by arrows 421 and 422, respectively. A user involved in the second stage of the bidding process may be said to be operating at a second level of classification.

Users, e.g., users 402A-B, operating at the second stage of the bidding process may import one or more of the line items contained in the primary bid request into one or more subsequent bid requests (hereinafter referred to as secondary bid requests) to one or more other users, e.g., sub-contractors, operating at a next lower level of classification 411. The one or more users that receive the secondary bid request may be said to be operating at a third level of classification as it is the third stage in the bidding process. For example, user 402A (hereinafter referred to as the secondary requester) may import one or more line items in the primary bid request into a secondary bid request to be transmitted to user 403A operating at the next lower level of classification 411C as illustrated by arrow 423. Furthermore, user 402A may import one or more line items in the primary bid request into a secondary bid request to be transmitted to user 403B operating at the next lower level of classification 411C as illustrated by arrow 424. Furthermore, user 402A may import one or more line items in the primary bid request into a secondary bid request to be transmitted to user 403C operating at the next lower level of classification 411C as illustrated by arrow 425. Similarly, user 402B may import one or more line items in the primary bid request into a secondary bid request to be transmitted to user 403B operating at the next lower level of classification 411C as illustrated by arrow 426. Likewise arrows 427 and 428 represent secondary bid requests transmitted to users 403C and 403D, which may include one or more line items imported from the primary bid request.

Likewise, users, e.g., users 403A-D, operating at the third stage of the bidding process may import one or more of the line items contained in the secondary bid request into one or more subsequent bid requests (hereinafter referred to as tertiary bid requests) to one or more other users, e.g., sub-sub-contractors, operating at a next lower level of classification 411. The one or more users that receive the tertiary bid request may be said to be operating at a fourth level of classification as it is the fourth stage in the bidding process. For example, user 403B may import one or more line items in the secondary request into a tertiary bid request to be transmitted to one or more of users 404A-F, e.g., 404A, 404D, operating at the next lower level of classification 411D as illustrated by arrows 429 and 431. Similarly, user 403A may import one or more line items in the secondary request into a tertiary bid request to be transmitted to one or more of users 404A-F, e.g., 404B, operating at the next lower level of classification 411D as illustrated by arrow 430. Similarly, user 403D may import one or more line items in the secondary request into a tertiary bid request to be transmitted to one or more of users 404A-F, e.g., 404C, 404E, 404F, operating at the next lower level of classification 411D as illustrated by arrows 432, 433 and 434, respectively.

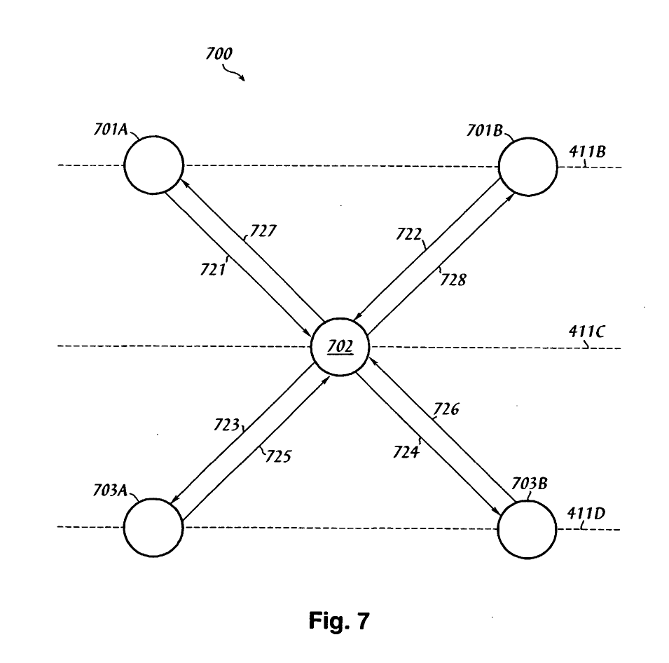

As stated above, hierarchical diagram 400 illustrates the flow of requests from one or more users operating at a next higher level of classification 411 to one or more users operating at a next lower level of classification 411. It is noted that hierarchical diagram 400 is illustrative and that the bidding process may comprise any number of stages, i.e., any number of levels of classification 411, involving any number of users, i.e., each level of classification 411 may comprise any number of users. It is further noted that each user may issue any number of requests to bid to any number of users operating at a next lower level of classification. It is further noted that each user may issue what is commonly referred to as a Request For Information (RFI) related to a received bid request to the requester of that bid request as described in greater detail in the description of FIG. 6. It is further noted that the line items in the bid requests may refer to the same or different projects. It is further noted that the line items in a particular bid request may be “aggregated” from two or more previously received bid requests that may refer to the same or different projects as described in greater detail in the description of FIG. 7.

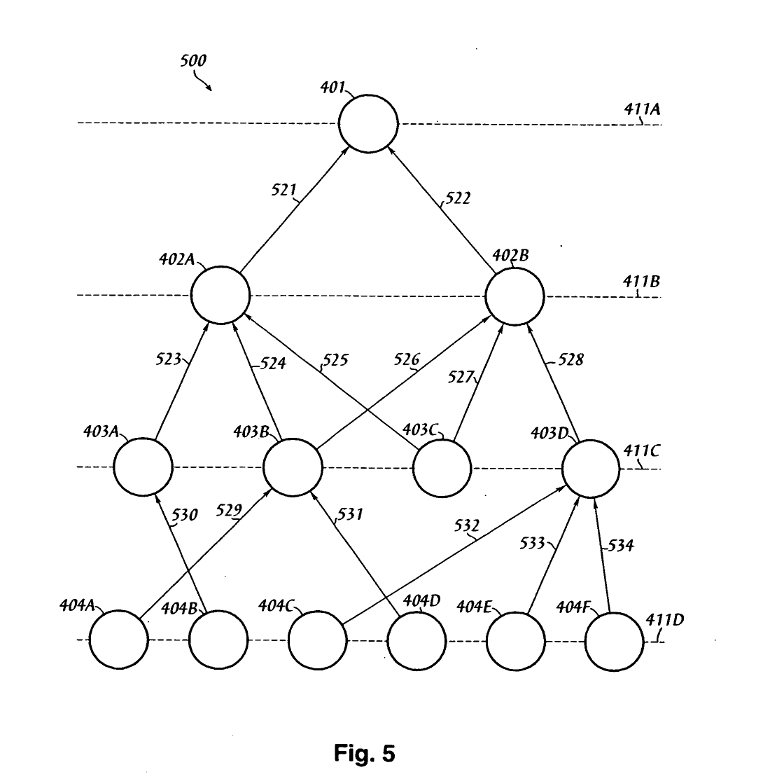

FIG. 5—Hierarchical Diagram of Overall Process for Responding to Bid Requests

FIG. 5 is a hierarchical diagram 500 of the overall process for responding to bid requests in accordance with the present invention. Hierarchical diagram 500 has the same corresponding levels of classification 411 and users as in hierarchical diagram 400. As stated above, the levels of classification 411 may refer to the stage at which the user(s) may be involved in the process of bidding on a particular project or portion thereof. It is noted that a single entity may engage in the bidding process at separate levels of classification 411 with respect to multiple bid requests relating to different projects or even the same project. Furthermore, hierarchical diagram 500 may further illustrate the flow of responses from one or more users operating at a next lower level of classification 411 to one or more users at a next higher level of classification 411 as indicated by arrows 521-534. It is noted that each user in a particular level of classification 411 may be a requester, i.e., transmit a request to one or more users operating at a lower level of classification 411. Each requester may receive one or more responses to one or more requests transmitted. The requester may then select data, e.g., price quotes, inputted by one or more users from the next lower level of classification related to one or more selected line items and import that selected data into a new response to be submitted to a requester operating at the next higher level of classification 411. It is further noted that hierarchical diagram 500 is illustrative and that the bidding process may comprise any number of stages, i.e., any number of levels of classification 411, involving any number of users, i.e., each level of classification 411 may comprise any number of users.

As noted above, a bid request may generically refer to a request to bid on line item(s) but could refer to a request for proposal or quotation as those terms would be understood by a person of ordinary skill in the art. Furthermore, the bid request may include some or all of the documentation, e.g., drawings, diagrams, specifications, instructions, agreements related to a specific line item or the request in general. As previously described in an embodiment such as in a Web-based environment, a request may include a link or links, or similar pointers to the documentation, or portions thereof. Furthermore, the bid request may refer to the same or different project where the line items in the bid request may be associated with different projects.

Hierarchical diagram 500 illustrates the flow of responding to bid requests from one or more users operating at a next lower level of classification 411 to one or more users at a next higher level of classification 411. For example, as discussed in conjunction with FIG. 4, users 404A-F at the fourth stage of the bidding process, i.e., operating at a fourth level of classification 411D, may receive a tertiary bid request from users 403A-D as illustrated by arrows 429-434 in FIG. 4. Users 404A-F may respond to a tertiary request by transmitting a response to one or more of the line items in a tertiary request to the tertiary requester, i.e., users 403A-D, as indicated by arrows 529-534.

Users, e.g., users 403A-D, operating at the third level of classification 411C, may import data, e.g., price quotes, related to one or more selected line items in one or more responses to one or more tertiary bid requests submitted from one or more users operating at the next lower level of classification 411, e.g., fourth level of classification 411D, into one or more new responses to one or more secondary bid requests to be submitted to one or more secondary requesters operating at a next higher level of classification, e.g., second level of classification 411B. For example, user 403B may import data, e.g., price quotes, related to one or more selected line items in the response to the tertiary bid request submitted by user 404A into one or more new responses to one or more secondary bid requests to be submitted to one or more secondary requesters, e.g., users 402A-B, operating at a next higher level of classification 411 as indicated by arrows 524 and 526. Similarly users 403A, 403C and 403D may respond to one or more secondary requesters, e.g., users 402A-B, operating at a next higher level of classification as indicated by arrows 523, 525, 527 and 528, respectively. Additionally, users, for example user 403C, may simply respond to one or more of the one or more line items in the secondary bid request to the secondary requesters, e.g., users 402A-B, without importing any response from any user operating at the fourth level of classification.

Users, e.g., users 402A-B, operating at the second level of classification 411B, may import data, e.g., price quotes, related to one or more selected line items in one or more responses received from one or more users operating at the next lower level of classification 411, e.g., third level of classification 411C, into one or more new responses to be submitted to one or more users operating at a next higher level of classification, e.g., first level of classification 411A. For example, user 402A may receive a response from one or more of users 403A-C to its bid request, i.e., secondary bid request, on one or more line items in the secondary bid request as indicated by arrows 523, 524 and 525, respectively. Similarly, user 402B may receive a response from one or more users 403B-D to its bid request, i.e., secondary bid request, on one or more line items in the secondary bid request as indicated by arrows 526, 527 and 528, respectively. Users 402A-B may decide to import data inputted by the sender on selected one or more line items into a response to be submitted to a primary requester operating at a next higher level of classification 411, e.g., user 401. For example, user 402A may submit a secondary bid request comprising line item #1 from the primary bid request which corresponds to furnishing and installing one hundred windows of a particular type and size to user 403A. User 402A also may submit a secondary bid request comprising line item #2 from the primary bid request which corresponds to furnishing and installing 10,000 square feet of a particular type of carpeting including the preparation of existing floor surfaces to user 403B. User 402A may submit a secondary bid request comprising line item #3 from the primary bid request which corresponds to furnishing and delivering one hundred desks of a particular type and size to user 403C. Users 403A, 403B and 403C may each respond by quoting a price to complete line items 1, 2 and 3, respectively. User 402A may then import the data related to those line items in the responses received from users 403A, 403B and 403C into its response to the primary bid request issued by the primary requester, operating at the next higher level of classification 411, e.g., user 401, as indicated by arrow 521. Similarly, user 402B may then import data related to one or more selected line items in the responses received from users 403B, 403C and 403D into its response to the primary bid request issued by the primary requester, operating at the next higher level of classification 411, e.g., user 401, as indicated by arrow 522. Note that the bid responses from users 403A, 403B and 403C to user 402A or from users 403B, 403C and 404D to user 402B may be “hidden.” That is, these responses may not be separately accessible to the requester operating at the next higher level of classification 411, e.g., user 401.

As stated above, hierarchical diagram 500 illustrates the flow of responses to bid requests from one or more users operating at a next lower level of classification 411 to one or more users operating at a next higher level of classification 411. It is noted that hierarchical diagram 500 is illustrative and that the bidding process may comprise any number of stages, i.e., any number of levels of classification 411, involving any number of users, i.e., each level of classification 411 may comprise any number of users. It is further noted that responses to bid requests may be responses related to the same or different projects. It is further noted that a response may include data, e.g., price quotes, related to line items that may have been “aggregated” from two or more previously transmitted requests that may refer to the same or different projects as described in greater detail in the description of FIG. 7. It is further noted that in the course of preparing a response to a bid request issued from a user at the next higher level of classification, each user responding may issue what is commonly referred to as a Request For Information (RFI), requesting further information related to the bid request transmitted by the requester as described in greater detail below.

FIG. 6—Method for Managing Requests for Information

FIG. 6 is a flowchart of one embodiment of the present invention, which includes a method 600 for managing Requests for Information (RFI's). As stated above, an RFI may refer to a request for information related to a bid request received. Referring to FIG. 4, a particular user, e.g., user 402A, may issue a bid request to one or more users, e.g., user 403A, at a next lower level of classification 411. The recipient, e.g., user 403A, may desire further information related to the bid request in order to determine how or if to respond to the bid request. The recipient, e.g., user 403A, may then issue an RFI related to the received bid request back to the requester, e.g., user 402A, of the bid request. Method 600 is a method for managing such RFIs as discussed below.

In step 601, a determination by a particular user, e.g., user 403A, may be made as to whether to issue an RFI to a particular user operating at a next higher level of classification, e.g., user 402A, in connection with a request previously received from that particular requester, e.g., user 402A. If the particular user, e.g., user 403A, determines not to issue an RFI then the particular user, e.g., user 403A, does not issue an RFI at step 602. If the particular user, e.g., user 403A, determines to issue an RFI to a user operating at a next higher level of classification, e.g., user 402A, in connection with a request previously received from that user, e.g., user 402A, then in step 603, the particular user, e.g., user 403A, may transmit the RFI from one of the clients 110, to be stored on at least one server 130. In one embodiment, the issuer of the RFI, e.g., user 403A (FIG. 4), may issue the RFI by transmitting the RFI from the client 110 that corresponds to the issuer of the RFI, via network 120, to at least one of server 130 (FIG. 1).

In step 640, system notifies the requester corresponding to the bid request, e.g., user 402A, that the RFI is available to be accessed. Upon receipt of notification, the requester determines whether or not to access the RFI in step 641. If the requester determines in step 641 not to access the RFI, then the process ends at step 642. Otherwise, if the requester determines in step 641 to access the RFI, then in step 604 the requester receives the RFI via network 120, from server 130.

In step 605, the particular user, e.g., user 402A, may determine whether to respond to the RFI received in step 604. If the particular user, e.g., user 402A, determines not to respond, then the particular user, e.g., user 402A, does not respond in step 606. If the particular user, e.g., user 402A, determines to respond, then a determination may be made in step 607 as to whether the particular user, e.g., user 402A, prepares its response and identifies one or more users operating at a next lower level of classification 411 authorized to access the response. In connection with preparing its response, the particular user, e.g., 402A, may issue an RFI to the requester at a next higher level of classification, e.g., user 401, by initiating a sub-process that performs steps 601 and 603.

If, in step 607, the particular user, e.g., user 402A, determines to authorize one or more users operating at a next lower level of classification 411 to access the response prepared, then the particular user identifies such one or more users operating at the third level of classification who are authorized to access the response and transmits the response to the RFI from the client 110, via the network, to at least one server 130 in step 608.

If the particular user, e.g., user 402A, determines, in step 607, not to authorize one or more users operating at a next lower level of classification 411 to access the response, then the particular user, e.g., user 402A, may determine whether to modify the RFI in step 609. If the particular user, e.g., user 402A, determines not to modify the RFI then the particular user, e.g., user 402A, may submit the RFI to a user operating at a next higher level of classification, e.g., user 401, in connection with a request previously received from that user, e.g., user 401, in step 610. If the particular user, e.g., user 402A, decides to submit the RFI to a user operating at a next higher level of classification, e.g., user 401, in connection with a request previously received from that user, e.g., user 401, then in step 610 the RFI is transmitted from the client 110 that corresponds to such user, e.g. user 402A, via network 120, to at least one of server 130.

If the particular user, e.g., user 402A, determines to modify the RFI then the particular user, e.g., user 402A, may modify the RFI accordingly in step 611. As used herein, “to modify” a RFI contemplates that a particular user, e.g., user 402A, creates a new RFI in step 601 and imports selected data from the RFI received from a user operating at a next lower level of classification, e.g., user 403A, in step 604. The particular user, e.g., user 402A, may add, delete or edit the imported data. In this manner, the database system, e.g., server 130 and database 140, may maintain each RFI, e.g., RFI received by user 402A, in its unaltered form so as to maintain a record of all communications between users at each level of classification 411 with respect to each bid request. For example, user 403A, as a recipient of a secondary bid request, may issue an RFI to user 402A as the secondary requester seeking additional information about the supports for light fixtures to be installed when the drawings included with the secondary bid request show that the air distribution system prevents a direct connection to the structure above. Because the RFI issued by user 403A may implicate separate issues relating to the design of the air handling system, user 402A may modify the RFI issued by user 403A to include a further inquiry related to the design of the air handling system prior to transmitting the RFI to user 401. In step 612, the particular user, e.g., user 402A, may submit the modified RFI to a user operating at a next higher level of classification, e.g., user 401, in connection with a request previously received from that user, e.g., user 401, by transmitting from the client 110 that corresponds to such user, e.g. user 402A, via network 120, to at least one of server 130.

In step 647, system notifies the requester corresponding to the bid request, e.g., user 401, that the RFI is available to be accessed. Upon receipt of notification, the requester determines whether or not to access the RFI in step 648. If the requester determines in step 648 not to access the RFI, then the process ends at step 649. Otherwise, if the requester determines in step 648 to access the RFI, then in step 613 the requester receives the RFI via network 120, from a server 130.

Referring to steps 610 and 612, in step 613, the particular user, e.g., user 401, may receive the modified RFI transmitted in step 612 or the unmodified RFI transmitted in step 610. In step 614, the particular user, e.g., user 401, that received the RFI in step 613 may determine whether to respond. If the particular user, e.g., user 401, that received the RFI in step 613 determines not to respond, then the particular user, e.g., user 401, may not respond in step 615. If the particular user, e.g., user 401, that received the RFI in step 613 determines to respond, then the particular user, e.g., user 401, may prepare its response and identify the one or more users operating at a next lower level of classification, e.g., user 402A, authorized to access the response in step 616, and the response is submitted by transmitting the response from the client 110 that corresponds to such user, e.g., user 401, via network 120, to at least one of server 130. In connection with preparing its response in step 616, a user other than a primary requester, may issue an RFI to a requester at a next higher level of classification 411, by initiating a sub-process that performs step 601 and step 603.

In step 650, system notifies the user submitting the RFI, e.g., user 402A, that the response to the RFI is available to be accessed. Upon receipt of notification, the user submitting the RFI determines whether or not to access the response to the RFI in step 651. If the user submitting the RFI determines in step 651 not to access the response to the RFI, then the process ends at step 652. Otherwise, if the user submitting the RFI determines in step 651 to access the response to the RFI, then in step 617 the user submitting the RFI receives the response via network 120, from a server 130.

In step 617, one or more users, e.g., user 402A, operating at a next lower level of classification 411 that are authorized to receive the response prepared and transmitted in step 616 may receive the response. It is noted that the one or more users operating at a next lower level of classification 411 authorized to receive the response in step 616 may or may not include the user, e.g., user 402A, that transmitted the RFI in step 610 or modified RFI in step 612.

In step 618, the one or more users, e.g., user 402A, operating at a next lower level of classification 411 that received the response in step 617 may determine whether to forward the response. If one or more users, e.g., user 402A, operating at a next lower level of classification 411 that received the response in step 617 determined not to forward the response, then those one or more users, e.g., user 402A, may not forward the response in step 619. If one or more users, e.g., user 402A, operating at a next lower level of classification 411 that received the response in step 617 determine to forward the response, then a determination may be made as to whether to modify the response in step 620.

If the one or more users, e.g., user 402A, that determined to forward the response in step 618 determined not to modify the received response, then those one or more users, e.g., user 402A, may forward the response to one or more users, e.g., user 403A, operating at a next lower level of classification 411 in step 621.

If the one or more users, e.g., user 402A, that determined to forward the response in step 618 determined to modify the received response, then those one or more users, e.g., user 402A, may modify the received response in step 622. To modify the response, a particular user, e.g. user 402A may create a new response as in step 611 and import selected data from the response received from a user at the next higher level of classification, e.g. user 401. The particular user, 402A, for example, may then add to, delete from, or otherwise edit the imported data. In this manner, the database system maintains each response in its unaltered form so as to maintain a record of all communications between users at each level of classification 411 with respect to each bid request. In step 623, the one or more users, e.g., user 402A, that modified the response in step 622 may submit the modified response to one or more users, e.g., user 403A, operating at a next lower level of classification 411.

In step 644, system notifies one or more users operating at the third level of classification authorized to access the response to the RFI, e.g., user 403A, that a response to an RFI is available for access. Upon receipt of notification, the requester determines whether or not to access the RFI in step 645. If the requester determines in step 645 not to access the RFI, then the process ends at step 646. Otherwise, if the requester determines in step 645 to access the RFI, then in step 624 the requester receives the RFI via network 120 from a server 130.

Referring to steps 621 and 623, in step 624, the one or more users, e.g., user 403A, operating at a next lower level of classification 411 may receive the forwarded response transmitted in step 621 or the modified response transmitted in step 623.

In step 625, the one or more users, e.g., user 403A, operating at a next lower level of classification 411 that received the response in step 624, may determine whether to issue an additional RFI. If one or more users, e.g., user 403A, operating at a next lower level of classification 411 that received the response in step 624, determine to issue an additional RFI, then those users, e.g., user 403A, may transmit an additional RFI in step 603.

If one or more users, e.g., user 403A, operating at a next lower level of classification 411 that received the response in step 624, determine not to issue an additional RFI, then those users, e.g., user 403A, may import the response received in step 624 into one or more responses to one or more requests that may be submitted to one or more users, e.g., user 404, associated at a next lower level of classification 411 in step 626.

FIG. 7—Hierarchical Diagram of Aggregation

FIG. 7 illustrates an embodiment of the present invention of a hierarchical diagram 700 illustrating aggregation. Hierarchical diagram 700 illustrates the flow of issuing and responding to aggregated bid requests between users of clients 110, which are represented as circles, within three levels of classification, e.g., levels of classification 411B-D, as indicated by the dashed lines in FIG. 7. The transfer of requests and responses illustrating aggregation may be represented by arrows 721-728 in FIG. 7. As stated above, the levels of classification 411 may refer to the stage the user(s) may be involved in the process of bidding on a particular project. Hierarchical diagram 700 may illustrate any three particular levels of classification 411 and that each level of classification 411 may comprise any number of users. It is further noted that aggregated requests and responses to aggregated requests may be transmitted through one or more users operating over multiple levels of classification 411. For example, a user operating in a second level of classification 411B may issue an aggregated request to one or more users operating in a third level of classification 411C that may further issue the aggregated request or a portion thereof to one or more users operating at the next lower level of classification, e.g., level of classification 411D, and so forth. The responses to the aggregated request(s) may be transmitted to the requester(s) through a similar process. It is further noted that the line items aggregated as discussed below may be associated with the same or different projects.

Hierarchical diagram 700 illustrates transmitting an aggregated bid request to one or more users operating in a next lower level of classification 411. An aggregated bid request may refer to aggregating line items in two or more received requests related to the same or different projects into one or more new requests to be transmitted to one or more users operating at a next lower level of classification. These new requests may be referred to as “aggregated bid requests.” An aggregated bid request may include some or all of the documentation, e.g., drawings, diagrams, specifications, instructions, agreements, related to a specific line item or the requests in general. In an embodiment in implemented accordance with a Web-based environment, an aggregated bid request may include links, or similar such pointers to the documentation or portions thereof.

Referring to FIG. 7, hierarchical diagram 700 illustrates one or more users, e.g., users 701A, 701B, in a particular level of classification 411, e.g., level of classification 411B, issuing one or more bid requests to one or more users, e.g., user 702, operating in a next lower level of classification 411, e.g., level of classification 411C. For example, user 701A operating at level of classification 411B may submit a bid request that includes line items 1, 3 and 5 related to project #1 to user 702 operating at the next lower level of classification 411, i.e., level of classification 411C, as indicated by arrow 721. Line item #1 may correspond to furnishing and installing one hundred desk chairs of a particular type and size. Line item #3 may correspond to furnishing and delivering one hundred desks of a particular type and size. Line item #5 may correspond to furnishing and installing one hundred windows of a particular type and size. User 701B operating at level of classification 411B may submit a bid request that includes line items 2, 4, 6 and 8 related to project #2 to user 702 operating at the next lower level of classification 411, i.e., level of classification 411C, as indicated by arrow 722. Line item #2 may correspond to furnishing and delivering one hundred conference room chairs of a particular type and size. Line item #4 may correspond to furnishing and installing 10,000 square feet of a particular type of carpeting including the preparation of existing floor surfaces. Line item #6 may correspond to furnishing and installing one hundred blinds of a particular type and size. Line item #8 may correspond to furnishing and delivering fifty desks of a particular type and size.

Hierarchical diagram 700 further illustrates one or more users, e.g., user 702, issuing aggregated bid requests to be transmitted to one or more users operating at a next lower level of classification, i.e., aggregating line items in two or more received requests related to the same or different projects into one or more new requests to be transmitted to one or more users operating at a next lower level of classification. For example, user 702 may aggregate one or more line items in the bid requests received from users 701A and 702B as identified by arrows 721 and 722, respectively. User 702 may aggregate line items 1 and 3 related to project #1 in the bid request received from user 701A with line items 2 and 8 related to project #2 in the bid request received from user 701B by importing selected data, e.g., description of goods, quantities, on the selected line items from such bid requests into an aggregated bid request to be transmitted to user 703A operating at a next lower level of classification 411, i.e., level of classification 411D, as identified by arrow 723. User 702 may further aggregate line item 5 related to project #1 in the bid request received from user 701A with line items 4 and 6 related to project #2 in the bid request received from user 701B by importing selected data, e.g., description of goods, quantities, on the selected line items from such bid requests into an aggregated bid request to be transmitted to user 703B operating at a next lower level of classification 411, i.e., level of classification 411D, as identified by arrow 724.

Hierarchical diagram 700 further illustrates selecting and importing data, e.g., price quotes, on selected line item(s) in responses to the transmitted aggregated bid request(s) into one or more responses to be submitted to one or more requesters operating at a next higher level of classification 411. For example, user 703A may submit a response to the received aggregated bid request, e.g., bid request on line items 1 and 3 for project #1 and line items 2 and 8 for project #2, to user 702 that issued the aggregated bid request as indicated by arrow 725. User 703B may submit a response to the received aggregated bid request, e.g., bid request on line item 5 for project #1 and line items 4 and 6 for project #2, to user 702 that issued the aggregated bid request as indicated by arrow 726.

User 702 may import selected data, e.g., price quotes, on selected line item(s) into one or more responses to be submitted to one or more requesters operating at a next higher level of classification 411. For example, user 702 may import data, e.g., price quotes, on selected line item(s), e.g., line items 1 and 3 related to project #1, from the response submitted by user 703A as indicated by arrow 725 and import data, e.g., price quotes, on selected line item(s), e.g., line item 5 related to project #1, from the response submitted by user 703B as indicated by arrow 726 into a response to be submitted to user 701A as indicated by arrow 727. User 702 may transmit the response that includes the response to line items 1, 3 and 5 related to project #1 to user 701A since user 701A had previously transmitted a bid request that included line items 1, 3 and 5 related to project #1 to user 702. User 702 may import selected data, e.g., price quotes, on selected line item(s), e.g., line items 2 and 8 related to project #2, from the response submitted by user 703A as indicated by arrow 725 and import selected data, e.g., price quotes, on selected line item(s), e.g., line items 4 and 6 related to project #2, from the response submitted by user 703B as indicated by arrow 726 into a response to be submitted to user 701B as indicated by arrow 728. User 702 may transmit the response that includes the response to line items 2, 4, 6 and 8 related to project #2 to user 701B since user 701B had previously transmitted a bid request that included line items 2, 4, 6 and 8 related to project #2 to user 702.

FIG. 8—Flowchart of a Method for Managing Bids

FIG. 8 is a flowchart of one embodiment of the present invention of a method 800 for managing bids. As stated in the Background Information section, a recipient of a bid request may need to sub-contract some or all of those line items in the request to other entities. That is, the recipient of the bid request may have to become a requester itself and issue a bid request on all or a portion of those items in the request received. Furthermore, a recipient may receive multiple bid requests. These multiple requests may comprise line items as well as the accompanying documentation, e.g., agreements, drawings, that need to be sub-contracted. Hence, the recipient may desire to aggregate line items and the accompanying documentation from multiple requests into a new bid request to sub-contractors. As previously described, in an embodiment of the present invention, such as a Web-based embodiment, requests may include links or similar such pointers to the documentation as an alternative to the documentation files themselves. It would therefore be desirable to develop a tool that allows a recipient of a bid request to submit one or more bid requests to other entities on all or a portion of the line items in the initial request. It would further be desirable to develop a tool that aggregates the line items and the accompanying documentation, e.g., agreements, drawings, from multiple bid requests into a new request that may be submitted to other entities. It would further be desirable to develop a tool that partitions the responses to these requests into a new response submitted to the appropriate entity. Method 800 is a method for submitting one or more requests to bid to other entities on a portion of the line items in the initial request. Furthermore, method 800 is a method for selecting and importing one or more line items into a new response to be submitted to the appropriate entity. Furthermore, method 800 is a method for aggregating the line items as well as the accompanying documentation from multiple requests into a new bid request that may be submitted to other entities. Furthermore, method 800 is a method for selecting and importing particular information from responses to an aggregated request into a new response to be submitted to the appropriate entity.

In step 801, a requester operating at a first level of classification 411, e.g., owner, may prepare one or more primary bid requests to be transmitted to one or more users operating at a second level of classification, e.g., general contractors, via network 120 (FIG. 1). A primary bid request may comprise a plurality of line items to be accomplished and related documentation, e.g., drawings, agreements, if any. Each line item may represent a particular task, e.g., installing windows, in order to complete a particular project, e.g., construction of a building. A primary bid request may also identify one or more users operating at a second level of classification 411 who are authorized to access such request. A primary bid request may be transmitted from one of the clients 110 and stored on at least one server 130. In one embodiment, the primary bid requester, e.g., user 401 (FIG. 4), may issue the primary bid request by transmitting a primary bid request containing one or more line items and related documentation, if any, from the client 110 that corresponds to the requester, via network 120, to at least one of server 130 (FIG. 1).

In step 802, system notifies one or more authorized users operating at a second level of classification to access the primary bid request that a primary bid request is available to be accessed. Upon receipt of notification, one or more authorized users operating at a second level of classification to access the primary bid request determines whether or not to access the primary bid request in step 803. If one or more authorized users operating at a second level of classification determines in step 803 not to access the primary bid request, then the process ends at step 804. Otherwise, if one or more authorized users operating at a second level of classification determines in step 803 to access the primary bid request, then in step 805 the bid request is transmitted to the authorized user by a server 103. (For purposes herein, transmission from a server to a user may also be referred to as “downloading.”) As a result of an evaluation of the bid request, in step 806, the one or more users that access the primary bid request determines whether to respond to the request. If one of the one or more users operating at the second level of classification that accessed the system in step 803 determines not to respond, then step 806 proceeds by the “NR” branch to step 807. In step 863, any one or more users operating at a second level of classification that determines in step 807 not to submit a response, selectively transmits a notification of its intent not to submit a response to the primary bid request. Note that step 863 may be performed asynchronously, that is, may be selectively initiated by user input 864, and may not be performed until user input is received. Process 800 terminates as to that user in step 863 with no response. Conversely, if one of the one or more users operating at a second level of classification that accessed the system in step 803 determines to respond, then step 806 proceeds by the “R” branch. In step 808, any one or more users operating at a second level of classification that determines in step 806 to submit a response, selectively transmits a notification to the primary requester of its intent to submit a response to the primary bid request. Note that step 808 may be performed asynchronously, that is, may be selectively initiated by user input 860, and may not be performed until user input is received.

In step 809, a user operating at a second level of classification, e.g., user 402A (FIG. 4), receiving the primary bid request may also determine whether to respond directly to the primary bid request or to issue one or more secondary bid requests to one or more users operating at a third level of classification. If the recipient of the primary bid request, e.g., user 402A, determines not to issue any secondary bid request on one or more of the one or more line items contained in the primary bid request, then in step 810, a response may be generated to one or more of the line items of the primary bid request and transmitted to at least one server 130. (For purposes herein, transmission from a user to a server may also be referred to as “uploading.”) In one embodiment, the recipient of the primary bid request, e.g., user 402A, may submit a response by transmitting pricing, delivery, warranty, general terms and conditions, documentation and other information relating to one or more of the one or more line items contained in the primary bid request to the primary requester. The transmission may be to a server, such as, server 130, via network 120. In step 811, the system transmits notification to the primary requester that one or more authorized users operating at a second level of classification have submitted a response to the primary requester, e.g., user 401. In step 812, the primary requester accesses the system from a client, e.g., a client 110 that corresponds to user 401, via network 120.

Returning to step 809, if a recipient of the primary bid request, e.g., user 402A, determines to issue one or more secondary bid requests, then in step 813 it determines whether or not to aggregate one or more of the one or more line items contained in primary bid requests into one or more secondary bid requests. If the recipient of the primary bid request, e.g., user 402A, determines not to aggregate in step 813, then in step 814 one or more secondary bid requests may be generated containing one or more of the one or more line items contained in the primary bid request and authorize one or more other users operating at a third level of classification, e.g., sub-contractors, to access one or more of the secondary bid requests.

If the recipient of the primary bid request, e.g., user 402A, determines to aggregate in step 813, then in step 815 one or more secondary bid request may be prepared containing one or more of the one or more line items contained in more than one primary bid request and authorize one or more other users operating at a third level of classification, e.g., sub-contractors, to access one or more of the secondary bid requests. In step 816, the system notifies the one or more users operating at the third level of classification authorized by the secondary requester, e.g., user 402A, to access one or more secondary bid requests, via the network 120, that such one or more secondary bid requests are available for access.

It is noted that a secondary bid request prepared in a corresponding one of steps 814 or step 815 may include documentation, e.g., agreements, drawings, related to the line item(s) or the secondary bid request in general, which were selected and imported from one or more primary bid requests or attached by the secondary requester.

One or more authorized users operating at a third level of classification determines whether or not to access the secondary bid request in step 817. If one or more authorized users in a third level of classification determines in step 817 not to access the secondary bid request, then the process ends at step 818. Otherwise, if one or more authorized users operating at a third level of classification determines in step 817 to access the secondary bid request, then in step 840 the bid request is downloaded to the authorized user by a server 130. In response to an evaluation of the bid request, in step 819, the one or more users that access the secondary bid request determines whether to respond to the request. If one of the one or more users operating at a third level of classification that accessed the system in step 817 determines not to respond, then step 819 proceeds by the “NR” branch to step 820. In step 865, any one or more users operating at a third level of classification that determines in step 820 not to submit a response, selectively transmits a notification of its intent not to submit a response to the secondary bid request. Note that step 865 may be performed asynchronously, that is, may be selectively initiated by user input 866, and may not be performed until user input is received. Process 800 terminates as to that user in step 865 with no response. Conversely, if one of the one or more users operating at third level of classification that accessed the system in step 819 determines to respond, then step 819 proceeds by the “R” branch. In step 821, any one or more users operating at a third level of classification that determines in step 819 to submit a response, selectively transmits a notification to the secondary requester of its intent to submit a response to the secondary bid request. Note that step 821 may be performed asynchronously, that is, may be selectively initiated by user input 862, and may not be performed until user input is received.

In step 842, a user operating at a third level of classification, e.g., user 403A (FIG. 4), receiving the secondary bid request also determines whether to respond directly to the secondary bid request or to issue one or more tertiary bid requests to one or more users operating at a fourth level of classification. If the recipient of the secondary bid request, e.g., user 403A, determines not to issue any tertiary bid request on one or more of the one or more line items contained in the secondary bid request, then in step 823, a response may be generated to one or more of the line items of the secondary bid request and the response uploaded to at least one server 130. In one embodiment, the recipient of the secondary bid request, e.g., user 402A, may submit a response by transmitting pricing, delivery, warranty, general terms and conditions, documentation and other information relating to one or more of the one or more line items contained in the secondary bid request to the secondary requester. The transmission may be to a server, such as, server 130, via network 120, FIG. 1. In step 824, the system transmits notification to the secondary requester that one or more authorized users operating at a third level of classification have submitted a response to the secondary bid request, e.g., user 402A. In step 825, the secondary requester accesses the system from a client, e.g., a client 110 that corresponds to user 402A, via the network 120.

Returning to step 842, if a recipient of the secondary bid request, e.g., user 403A determines to issue one or more tertiary bid requests, then in step 822 it determines whether or not to aggregate one or more of the one or more line items contained in one or more secondary bid requests into one or more tertiary bid requests. If the recipient of the secondary bid request, e.g., user 403A, determines not to aggregate in step 822, then in step 827 one or more tertiary bid requests may be generated containing one or more of the one or more line items contained in the secondary bid request and authorize one or more other users operating at a fourth level of classification, e.g., sub-contractors, to access one or more of the tertiary bid requests.

If the recipient of the secondary bid request, e.g., user 403A, determines to aggregate in step 822, then in step 826 it prepares one or more tertiary bid requests containing one or more of the one or more line items contained in more than one secondary bid request and authorizes one or more other users operating at a fourth level of classification, e.g., sub-sub-contractors, to access one or more of the tertiary bid requests.

In step 844, the system notifies the one or more authorized users operating at the fourth level of classification authorized by the tertiary requester, e.g., user 403A, to access one or more tertiary bid requests, via the network 120, that such one or more tertiary bid requests are available for access.

It is noted that a tertiary bid request prepared in a corresponding one of steps 826 or step 827 may include documentation, e.g., agreements, drawings, related to the line item(s) or the tertiary bid request in general, which were selected and imported from one or more secondary bid request or attached by the tertiary requester.

In the embodiment of process 800, the process steps through three levels of classification have been illustrated. However, it would be recognized that corresponding process steps may be replicated through any number, n, of levels of classification in accordance with the present inventive principles. Additionally the terminology primary, secondary and tertiary are not intended to be limiting as to cardinality and other terms may be used to denote levels of classification.

Returning to step 825, a secondary requestor accessing the system may then respond to the primary request in view of the responses to the secondary request generated, in step 823, by one or more authorized users operating at a third level of classification. A response by a secondary user may be generated in accordance with subprocess 850. Note that a particular user may have a plurality of subprocess 850, corresponding to a submission of bid responses to a plurality of bid requests which need not, necessarily, be related.

In step 828, a determination is made whether to import the one or more responses generated by users operating at a third level of classification, accessed in step 825, into an analysis tool. For example, an analysis tool may indicate the lowest combination for all line items derived from all responses imported into the analysis tool. Additionally, the analysis tool may provide an indicator of the lowest value for each line item attribute, for example, lowest unit price, lowest aggregated price, lowest labor costs, etc. These analyses are exemplary and additionally or another analysis that may be performed by an embodiment of an analysis tool would be understood to fall within the spirit and scope of the present invention.

If, in step 828 it has been determined to import responses into the analysis tool, in step 829 responses are selected for analysis, in step 830 the responses selected in step 829 are analyzed.

Subprocess 850 then proceeds to three-way decision block, step 831. (For example, in the C programming language implementation, step 831 may be a switch statement.) In step 831A, the secondary user may select to generate a secondary response to the primary bid request by importing selected data from the response from the user operating at a third level of classification. Otherwise, user, in step 831B may selectively import selected data from a response from a user at a third level of classification into an existing secondary response. If, the secondary user selects either of these, in step 832, such user determines if the response to the primary bid request is to be submitted. If so, in step 833, a notification is transmitted to the requestor of the primary bid request corresponding to the response being generated, similarly to step 811, discussed hereinabove. In step 834, the response to the primary bid request generated by the user at the second level of classification is uploaded to the system.

Note that once a response has been submitted, it may not be unilaterally retracted. A response submitted by a user at a particular level of classification, in accordance with the principles of the present invention, may “roll up” into bid responses at each higher level of classification. Consequently, a retraction of a response at a particular level, may affect responses at each higher level of classification. A response may be recalled only if such recall is approved by the corresponding requester at each higher level of classification. If the recall of a response is approved, the response may be maintained in the system, with a status of “Recalled.”

Returning to step 832, if a response to the secondary request is not yet ready for submission, in step 835a determination is made if the current subprocess 850 is to be exited. Recall, as discussed hereinabove, that a particular user may be responding to a multiplicity of requests, and a subprocess 850 may be spawned with respect to each of these. If, in step 835, the current subprocess 850 is to be exited, step 835 proceeds by the “Yes” branch and the subprocess 850 exists, step 839. The user may subsequently re-enter to subprocess 850, step 837, to continue generating a response. Otherwise, step 835 proceeds by the “No” branch and the subprocess 850 returns to step 825 at step 836 to access additional responses, if any.

Returning to step 831, if, in three-way decision block 831, the user has selected neither to generate secondary response and import a response (step 831A), nor to import a response into an existing secondary response (step 831B), then three-way decision block 831 proceeds to step 835, and the user may selectively exit the subprocess, or return to step 825, as previously described.

Returning now to step 828, if it is determined not to import responses accessed in step 825 into the analysis tool, the secondary user may view the responses, step 836. Then subprocess 850 proceeds to three-way decision block 831, and the secondary user may selectively generate a response and import, or may import a response into an existing secondary response, or neither, as previously described.

Process 800, including subprocess 850 has been discussed hereinabove in conjunction with the submission of bid requests and responses thereto. However, additionally, in accordance with the principles of the present invention, users at any level of classification, may change elements of a request any particular user initially submitted. Such changes may be referred to as an addendum or addenda and submission of such addenda and responses thereto, may performed by the analogous process steps of methodology 800.

It is noted that method 800 may be executed in a different order presented and that the order presented in the discussion of FIG. 8 is illustrative. It is further noted that certain steps may be executed almost concurrently.

Although the method, computer program product and system and are described in connection with several embodiments, it is not intended to be limited to the specific forms set forth herein, but on the contrary, it is intended to cover such alternatives, modifications, and equivalents, as can be reasonably included within the spirit and scope of the invention as defined by the appended claims. It is noted that the headings are used only for organizational purposes and not meant to limit the scope of the description or claims.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A method for managing a bid comprising the steps of:
transmitting a first request to submit a first bid by a first requester at a first level of classification to one or more entities at a second level of classification, wherein said first request to submit said first bid comprises one or more line items;
submitting a first bid response to one or more of said one or more line items of said first bid to said first requester at said first level of classification by one or more of said one or more entities at said second level of classification in response to said first request; and
transmitting a second request to submit a second bid on one or more of said one or more line items of said first bid to one or more entities at a third level classification by one or more of said one or more entities at said second level of classification.

2. The method as recited in claim 1 further comprising the steps of:
receiving one or more responses to said second request to submit said second bid; and
importing selected data from at least one of said one or more responses to said second request into said first bid response by one or more of said one or more entities at said second level of classification.

3. The method as recited in claim 2, wherein said at least one of said one or more responses to said second request is not separately accessible to said first requester at said first level of classification.

4. The method as recited in claim 1 further comprising the step of:
uploading said first request to submit said first bid to one or more entities at said second level of classification to a database server, and wherein said step of submitting said first bid response includes uploading said first bid response to said database server.

5. The method as recited in claim 4 further comprising the step of:
receiving a third request to submit a third bid by one or more entities at said second level of classification, wherein said third request to submit said third bid comprises one or more line items, wherein said third request is issued by a third requester at said first level of classification and wherein said step of receiving said third request includes accessing said database server and downloading said third bid request from said database server;
aggregating by one or more of said one or more entities at said second level of classification one or more of said one or more line items in said first and said third request into a fourth request to submit a fourth bid; and
issuing said fourth request to submit said fourth bid to one or more entities at said third level classification.

6. The method as recited in claim 5 further comprising the step of:
receiving one or more responses to said fourth request;
importing selected data from a first one or more responses to one or more line items in said one or more responses to said fourth request into a third bid response, wherein said third bid response is a bid response to said third request;
submitting said third bid response to said third requester;
importing selected data from a second one or more responses to one or more line items in said one or more responses to said fourth request into said first bid response; and
submitting said first bid response to said first requester.

7. The method as recited in claim 1, wherein said first request to submit said first bid further comprises documentation associated with one or more of said one or more line items.

8. The method as recited in claim 7, wherein said second request to submit said second bid comprises documentation associated with at least one of said one or more of said one or more line items of said first bid.

9. The method as recited in claim 4 further comprising the step of:
receiving a request for information from one of said one or more entities at said third level of classification by one of said one or more entities at said second level of classification wherein said step of receiving said request for information includes downloading said request for information from said database server.

10. The method as recited in claim 9 further comprising the step of:
issuing a response to said request for information to one or more of said one or more entities at said third level of classification by said one of said one or more entities at said second level of classification that received said request for information wherein said step of issuing said response to said request for information includes uploading said response to said request for information to said database server.

11. The method as recited in claim 9 further comprising the step of:
transmitting said received request for information to one or more entities at said first level of classification by said one of said one or more entities at said second level of classification.

12. A computer program product having computer readable medium having computer program logic recorded thereon for managing a bid, comprising:
programming operable for transmitting a first request to submit a first bid by a first requester at a first level of classification to one or more entities at a second level of classification, wherein said first request to submit said first bid comprises one or more line items;
programming operable for submitting a first bid response to one or more of said one or more line items of said first bid to said first requester at said first level of classification by one or more of said one or more entities at said second level of classification in response to said first request; and
programming operable for transmitting a second request to submit a second bid on one or more of said one or more line items of said first bid to one or more entities at a third level classification by one or more of said one or more entities at said second level of classification.

13. The computer program product as recited in claim 12 further comprises:
programming operable for receiving one or more responses to said second request to submit said second bid; and
programming operable for importing selected data from at least one of said one or more responses to said second request into said first bid response by one or more of said one or more entities at said second level of classification.

14. The computer program product as recited in claim 13, wherein said at least one of said one or more responses to said second request is not separately accessible to said first requester at said first level of classification.

15. The computer program product as recited in claim 12 further comprises:
programming operable for uploading said first request to submit said first bid to one or more entities at said second level of classification to a database server, and wherein said step of submitting said first bid response includes uploading said first bid response to said database server.

16. The computer program product as recited in claim 15 further comprises:
programming operable for receiving a third request to submit a third bid by one or more entities at said second level of classification, wherein said third request to submit said third bid comprises one or more line items, wherein said third request is issued by a third requester at said first level of classification and wherein said programming for receiving said third request includes programming for accessing said database server and downloading said third bid request from said database server;
programming operable for aggregating by one or more of said one or more entities at said second level of classification one or more of said one or more line items in said first and said third request into a fourth request to submit a fourth bid; and
programming operable for issuing said fourth request to submit said fourth bid to one or more entities at said third level classification.

17. The computer program product as recited in claim 16 further comprises:
programming operable for receiving one or more responses to said fourth request;
programming operable for importing selected data from a first one or more responses to one or more line items in said one or more responses to said fourth request into a third bid response, wherein said third bid response is a bid response to said third request;
programming operable for submitting said third bid response to said third requester;
programming operable for importing selected data from a second one or more responses to one or more line items in said one or more responses to said fourth request into said first bid response; and
programming operable for submitting said first bid response to said first requester.

18. The computer program product as recited in claim 12, wherein said first request to submit said first bid further comprises documentation associated with one or more of said one or more line items.

19. The computer program product as recited in claim 18, wherein said second request to submit said second bid comprises documentation associated at least one of said one or more of said one or more line items of said first bid.

20. The computer program product as recited in claim 15 further comprises:
programming operable for receiving a request for information from one of said one or more entities at said third level of classification by one of said one or more entities at said second level of classification wherein said programming for receiving said request for information includes downloading said request for information from said database server.

21. The computer program product as recited in claim 20 further comprises:
programming operable for issuing a response to said request for information to one or more of said one or more entities at said third level of classification by said one of said one or more entities at said second level of classification that received said request for information wherein said step of issuing said response to said request for information includes uploading said response to said request for information to said database server.

22. The computer program product as recited in claim 20 further comprises:
programming operable for transmitting said received request for information to one or more entities at said first level of classification by said one of said one or more entities at said second level of classification.

23. A system, comprising:
a data processing system comprising:
a processor;
a memory unit operable for storing a computer program operable for managing a bid;
an input mechanism;
an output mechanism operable for connecting to said network; and
a bus system coupling the processor to the memory unit, input mechanism, and output mechanism, wherein the computer program is operable for performing the following programming steps:
transmitting a first request to submit a first bid by a first requester at a first level of classification to one or more entities at a second level of classification, wherein said first request to submit said first bid comprises one or more line items;
submitting a first bid response to one or more of said one or more line items of said first bid to said first requester at said first level of classification by one or more of said one or more entities at said second level of classification in response to said first request; and
transmitting a second request to submit a second bid on one or more of said one or more line items of said first bid to one or more entities at a third level classification by one or more of said one or more entities at said second level of classification.

24. The system as recited in claim 23, wherein the computer program is further operable for performing the following programming steps:
receiving one or more responses to said second request to submit said second bid; and
importing selected data from at least one of said one or more responses to said second request into said first bid response by one or more of said one or more entities at said second level of classification.

25. The system as recited in claim 24, wherein said at least one of said one or more responses to said second request is not separately accessible to said first requester at said first level of classification.

26. The system as recited in claim 23 further comprising:
a database server connected to said data processing system via a network, wherein the computer program is further operable to perform the following programming step:
uploading said first request to submit said first bid to one or more entities at said second level of classification to said database server, and wherein said programming step of submitting said first bid response includes a programming step of uploading said first bid response to said database server.

27. The system as recited in claim 26, wherein the computer program is further operable for performing the following programming steps:
receiving a third request to submit a third bid by one or more entities at said second level of classification, wherein said third request to submit said third bid comprises one or more line items, wherein said third request is issued by a third requester at said first level of classification wherein said programming step of receiving said third bid request includes programming steps for accessing said database server and downloading said third bid request from said database server;
aggregating by one or more of said one or more entities at said second level of classification one or more of said one or more line items in said first and said third request into a fourth request to submit a fourth bid; and
issuing said fourth request to submit said fourth bid to one or more entities at said third level classification.

28. The system as recited in claim 27, wherein the computer program is further operable for performing the following programming steps:
receiving one or more responses to said fourth request;
importing selected data from a first one or more responses to one or more line items in said one or more responses to said fourth request into a third bid response, wherein said third bid response is a bid response to said third request;
submitting said third bid response to said third requester;
importing selected data from a second one or more responses to one or more line items in said one or more responses to said fourth request into said first bid response; and
submitting said first bid response to said first requester.

29. The system as recited in claim 21, wherein said first request to submit said first bid further comprises documentation associated with one or more of said one or more line items.

30. The system as recited in claim 29, wherein said second request to submit said second bid comprises documentation associated with at least one of said one or more of said one or more line items of said first bid.

31. The system as recited in claim 26, wherein the computer program is further operable for performing the following programming step:
receiving a request for information from one of said one or more entities at said third level of classification by one of said one or more entities at said second level of classification wherein said programming step for receiving said request for information includes programming steps for downloading said request for information from said database server.

32. The system as recited in claim 31, wherein the computer program is further operable for performing the following programming step:
issuing a response to said request for information to one or more of said one or more entities at said third level of classification by said one of said one or more entities at said second level of classification that received said request for information wherein said step of issuing said response to said request for information includes uploading said response to said request for information to said database server.

33. The method as recited in claim 31, wherein the computer program is further operable for performing the following programming step:
transmitting said received request for information to one or more entities at said first level of classification by said one of said one or more entities at said second level of classification.
